(19) United States
(12) Patent Application Publication
(10) Pub. No.: US 2011/0253782 A1
(43) Pub. Date: Oct. 20, 2011

(54) LOADED DUMMY TRACK RUNNING ALONGSIDE THE CARD DATA LINES CARRYING DUMMY DATA

(76) Inventors: Andrew Campbell, Canterbury (GB); Brian Docherty, Sketty (GB); James Churchman, Llysworney (GB); Kevin Maidment, Penllyn (GB); Nick McGarvey, Whiteway Hill (GB)

(21) Appl. No.: 13/087,603

(22) Filed: Apr. 15, 2011

Related U.S. Application Data
(60) Provisional application No. 61/325,327, filed on Apr. 18, 2010.
(60) Provisional application No. 61/325,289, filed on Apr. 17, 2010.
(60) Provisional application No. 61/325,291, filed on Apr. 17, 2010.
(60) Provisional application No. 61/325,300, filed on Apr. 17, 2010.
(60) Provisional application No. 61/331,432, filed on May 5, 2010.

(51) Int. Cl. G06K 7/00

(52) U.S. Cl. 235/435

(57) ABSTRACT

Dummy data wires or PCB tracks are employed that run close to and parallel with the wires or tracks that carry the actual data between the card and the microprocessor. These dummy data tracks or wires are driven with dummy random data at a similar data rate to that used on the real data track(s) or wire(s). As the dummy tracks or wires are close to the “real” data tracks or wires and the dummy data is random, attempts to capacitively sense the actual data will be disrupted. To counter this method of detection the dummy data track may be connected to loads (resistive, capacitive or both) to ensure that current flows when dummy data is applied to the tracks. The loads may be selected such that the current flows are similar to those in the real data track. This is achieved by determining the terminating impedances on the real data track and using similar values on the dummy data tracks. Or, the strategy may be to ensure that the current flow in the dummy data tracks are much higher than the real data track current, in which case the total magnetic field will be dominated by the dummy data and the “real” signal will be “drowned out” by the dummy data signals.

### CROSS-REFERENCE TO RELATED APPLICATIONS

The present application claims priority from Provisional U.S. Patent Application Ser. No. 61/325,327, filed on Apr. 18, 2010, and incorporated herein by reference.

The subject matter of the present application is also related to the following Provisional U.S. Patent Applications, all of which are incorporated herein by reference:

Ser. No. 61/325,289, filed on Apr. 17, 2010 (DAMALAK-0002P);

Ser. No. 61/325,291, filed on Apr. 17, 2010 (DAMALAK-0003P);

Ser. No. 61/325,300, filed on Apr. 17, 2010 (DAMALAK-0004P);

Ser. No. 61/325,327, filed on Apr. 18, 2010 (DAMALAK-0005P); and

Ser. No. 61/331,432, filed on May 5, 2010 (DAMALAK-0006P).

### FIELD OF THE INVENTION

The present invention relates to Point of Sale Credit Card and Payment Terminals. In particular, the present invention is directed toward improved security for Point of Sale Credit Card and Payment Terminals.

### BACKGROUND OF THE INVENTION

In a card payment terminal, serial data is exchanged between the card inserted in the reader slot of the terminal and the processing electronics within the terminal (e.g., the microprocessor). Generally, card payment terminals are designed to detect attempts to open or otherwise tamper with them in order to intercept data exchanged between the card and the processing electronics (generally a microprocessor). Fraudsters may go to great lengths to tamper with or modify card terminal apparatus. If a terminal can be modified in such a way that signals can be intercepted and routed out of the terminal in such a way as to be invisible or at least not obvious to a user then the chances of obtaining private data for fraudulent use are increased.

A potential fraudster may therefore attempt to sense the data without making direct contact with the wire or track (PCB track) connecting the card terminal to the microprocessor. The sensors may be attached to the outside of the terminal case or perhaps hidden within internal battery compartments or the like. They can work by sensing the voltage on the data tracks or wires (capacitive sensing) or by sensing the magnetic field produced by the current in the data wires or tracks either by inductive sensing whereby changes in the magnetic field induce current in a sensing coil or using methods (such as hall effect devices of magneto-resistive materials) that sense the actual value of the magnetic field (rather than its rate of change). Conceivably, a combination of these methods may be employed.

Thus, it remains a requirement in the art to provide an improved security system for credit card and payment terminals and other sensitive electronic devices, to detect the presence of a shim and disable the card reader or notify the user that security may be compromised, when a shim is detected.

### SUMMARY OF THE INVENTION

The present invention comprises a card terminal called “PayPod” which includes a device for accepting and connecting to a standard Smart Card. There are five active connections for the smart card, including Power, Ground, Card clock, Card reset, and Card data.

The present invention is designed to make the reliable detection of the data being sent to or received from the card (via the Card Data connection) difficult to achieve by methods not requiring a direct electrical connection to the wire or printed circuit track(s) carrying data between the smart card and the processing electronics circuits (e.g., a microprocessor).

In a card payment terminal, serial data is exchanged between the card inserted in the reader slot of the terminal and the processing electronics within the terminal (e.g., microprocessor). In order to defeat such attempts to intercept the data, the following techniques are described.

In the preferred embodiment of the present invention, “dummy data” wires or PCB tracks are employed that run close to and parallel with the wires or tracks that carry the actual data between the card and the microprocessor. These dummy data tracks or wires are driven with dummy random data at a similar data rate to that used on the real data track(s) or wire(s). As the dummy tracks or wires are close to the “real” data tracks or wires and the dummy data is random, attempts to capacitively sense the actual data will be disrupted.

Of course, with un-terminated dummy data tracks (connected to the microprocessor at one end but to nothing at the other), little current will flow (the data rate being low enough that it will be far below any resonance with the likely track lengths used in practice). The real data track(s) will of course connect to the smart card and this connection will represent a load such that current will flow when a voltage is applied to the track. This means that data could be detected by remotely sensing the magnetic field due to current flow in the data track even when dummy data is present on the dummy data tracks (since no current flows along these tracks).

To counter this method of detection the dummy data track may be connected to loads (resistive, capacitive or both) to ensure that current flows when dummy data is applied to the tracks. The loads may be selected such that the current flows are similar to those in the real data track. This is achieved by determining the terminating impedances on the real data track and using similar values on the dummy data tracks. Alternately, the strategy may be to ensure that the current flow in the dummy data tracks are much higher than the real data track current, in which case the total magnetic field will be dominated by the dummy data and the “real” signal will be “drowned out” by the dummy data signals.

### BRIEF DESCRIPTION OF THE DRAWINGS

FIG. 1 is a schematic diagram illustrating a first embodiment of the present invention.

FIG. 2 is a schematic diagram illustrating a second embodiment of the present invention.

FIG. 3 is a schematic diagram illustrating a third embodiment of the present invention.

FIG. 4 is a frontal view of the PayPod card terminal of the present invention.

### DETAILED DESCRIPTION OF THE INVENTION

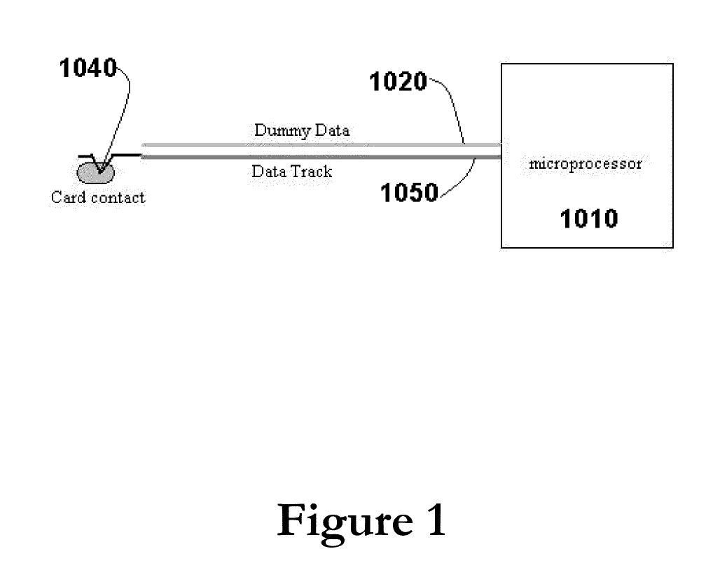

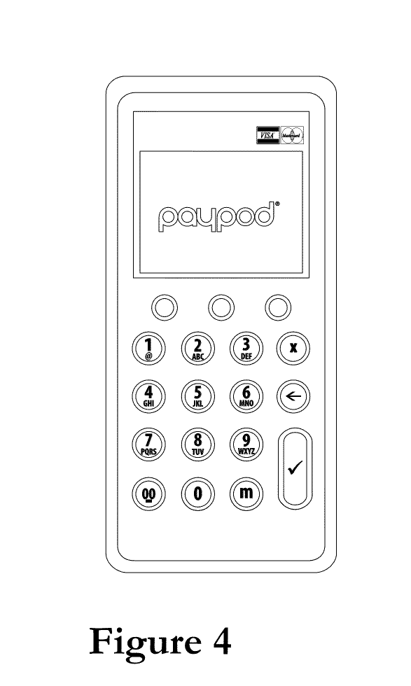

FIG. 4 is a frontal view of the PayPod card terminal of the present invention. The device includes a display, a keypad for inputting PIN numbers, payment amounts, and the like, and a card reader contact pad for accepting and connecting to a standard Smart Card. Referring to FIG. 1, “dummy data” wires or PCB tracks 1020 are employed that run close to and parallel with the wires or tracks 1050 that carry the data between the card contact 1040 and the microprocessor 1010. These dummy data tracks or wires 1020 are driven with dummy random data at a similar data rate to that used on the real data track(s) or wire(s) 1050. As the dummy tracks or wires 1020 are in close proximity to the “real” data tracks or wires 1050 and the dummy data is random, attempts to capacitively sense the will be disrupted.

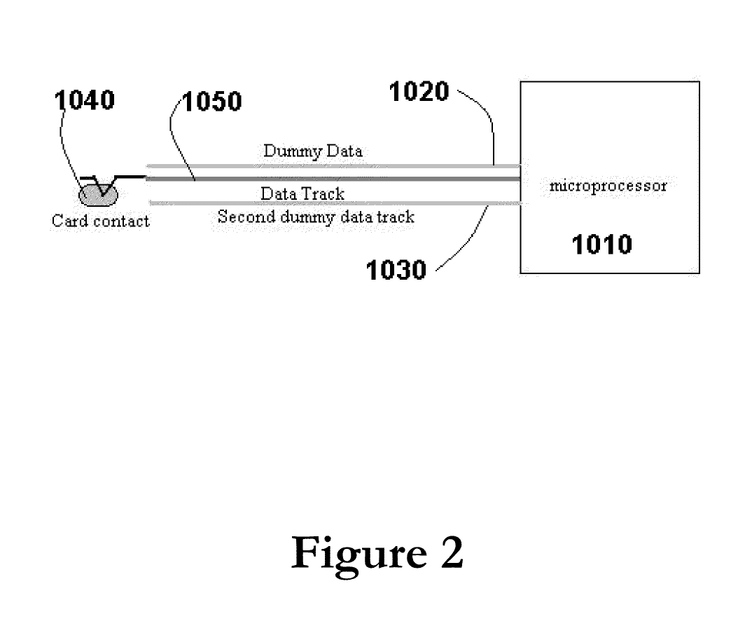

FIG. 2 is a schematic diagram illustrating a second embodiment of the present invention. In the embodiment of FIG. 2, a second dummy data track 1030 may be provided adjacent the data track 1050 (e.g., on an opposite side or different layer of the PCB) to further obfuscate data track signals from outside detection using inductive or capacitive means.

Of course, with un-terminated dummy data tracks 1020, 1030 (connected to the microprocessor 1010 at one end but to nothing at the other), little current will flow (the data rate being low enough that it will be far below any resonance with the likely track lengths used in practice). The real data track(s) 1050 will of course connect to the smart card contact 1040 and this connection will represent a load such that current will flow when a voltage is applied to the track 1050. This means that data could be detected by remotely sensing the magnetic field due to current flow in the data track 1050 even when dummy data is present on the dummy data tracks 1020, 1030 (since no current flows along these tracks).

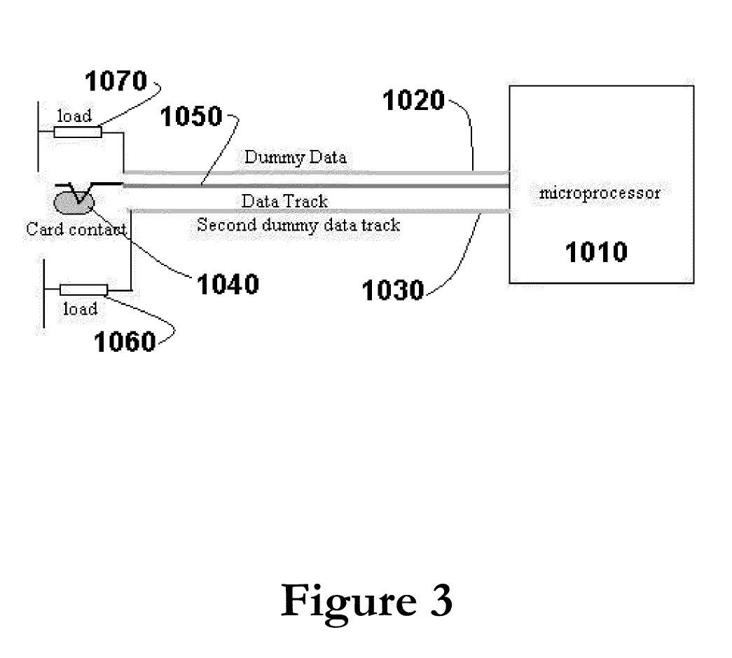

To counter this method of detection the dummy data track(s) 1020, 1030 may be connected to loads 1060, 1070 (resistive, capacitive or both) to ensure that current flows when dummy data is applied to the dummy track(s) 1020, 1030. FIG. 3 is a schematic diagram illustrating a third embodiment of the present invention. As illustrated in FIG. 3, the loads 1060, 1070 may be chosen such that the current flows are similar to those in the real data track 1050. This is achieved by determining the terminating impedances on the real data track 1050 and using similar values on the dummy data track(s) 1020, 1030. Or, the strategy may be to ensure that the current flow in the dummy data track(s) 1020, 1030 are much higher than the current n the real data track 1050, in which case the total magnetic field will be dominated by the dummy data and the “real” signal will be “drowned out”. Of course, the loads 1060, 1070 may be carefully selected so that current in the dummy data track(s) 1020, 1030 does not interfere with actual card data or normal functioning of the device, by inducing currents into the data track 1050.

Thus, in the present invention, if a hacker or other unauthorized person attempts to read card data using non-invasive means (inductive pickups, capacitive detection, RF measurement or the like) the resulting signal will be masked by the random dummy data and the card data will not be discernable. In addition, the use of dummy data track(s) 1020, 1030 provides additional protection against invasive measurement, where a hacker or other unauthorized person attempts to connect to actual circuit board traces (e.g., by drilling a hole in the cabinet of the device) by presenting a confusing array of data tracks, some transmitting “real” data and others transmitting dummy data.

While disclosed herein in the context of a Credit Card and Payment terminal, the present invention may also be applied to any type of sensitive electronic device, where data protection and anti-tampering features are desirable. Such applications include, but are not limited to, Automated Teller Machines (ATMs), Cable and Satellite Television decoders (set-top boxes), Cellular telephones, Personal Digital Assistants, and the like.

While the preferred embodiment and various alternative embodiments of the invention have been disclosed and described in detail herein, it may be apparent to those skilled in the art that various changes in form and detail may be made therein without departing from the spirit and scope thereof.

We claim:

1. An apparatus for masking data signals in a smart card reader to prevent sensing of data signals from within or without of the smart card reader, the apparatus comprising:
a card contact for transmitting and receiving data signals to and from a smart card;
a processor, coupled to the card contact, for processing data signals transmitted to and received from the smart card;
a data track coupling the card contact to the processor, for transmitting and receiving data signals between the card contact and the processor; and
at least one dummy track, coupled to the processor and located adjacent to the data track,
wherein the processor generates dummy data on the at least one dummy track so as to mask data signals on the data track, to prevent sensing of data signals from within or without of the smart card reader.

2. The apparatus for masking data signals in a smart card reader of claim 1, wherein the at least one dummy track further comprises at least two dummy tracks, located on different layers of a printed circuit board carrying the data track.

3. The apparatus for masking data signals in a smart card reader of claim 1, further comprising:
at least one load, coupled to a respective one of the at least one dummy track, the at least one load being predetermined to draw a predetermined amount of current through the at least one dummy track to produce a predetermined magnetic field level so as to mask data signals on the data track.

4. The apparatus for masking data signals in a smart card reader of claim 3 wherein the at least one load is predetermined to draw a predetermined amount of current through the at least one dummy track while not interfering with data on the data track.

5. A method of masking data signals in a smart card reader to prevent sensing of data signals from within or without of the smart card reader, the method comprising the steps of:
transmitting and receiving data signals to and from a smart card though a smart card contact, coupled to a processor processing data signals transmitted to and received from the smart card by a data track, and
generating, from the processor, dummy data on at least one dummy track located adjacent to the data track, so as to mask data signals on the data track, to prevent sensing of data signals from within or without of the smart card reader.

6. The method of masking data signals in a smart card reader of claim 5, wherein the step of generating, from the processor, dummy data on at least one dummy track located adjacent to the data track, so as to mask data signals on the data track, to prevent sensing of data signals from within or without of the smart card reader comprises the step of:
generating, from the processor, dummy data on at least two dummy tracks located on different layers of a printed circuit board carrying the data track, so as to mask data signals on the data track, to prevent sensing of data signals from within or without of the smart card reader.

7. The method of masking data signals in a smart card reader of claim 5, wherein the step of generating dummy data on the at least one dummy track coupled to a respective at least one load, the at least one load being predetermined to draw a predetermined amount of current through the at least one dummy track to produce a predetermined magnetic field level so as to mask data signals on the data track.

8. The method of masking data signals in a smart card reader of claim 7, wherein the at least one load is predetermined to draw a predetermined amount of current through the at least one dummy track while not interfering with data on the data track.
